(19) United States
(12) Patent Application Publication
(10) Pub. No.: US 2016/0048399 A1
(43) Pub. Date: Feb. 18, 2016

(54) ORCHESTRATED SENSOR SET

(71) Applicant: AT&T INTELLECTUAL PROPERTY I, L.P., Atlanta, GA (US)

(72) Inventor: Venson Shaw, Kirkland, WA (US)

(21) Appl. No.: 14/461,029

(22) Filed: Aug. 15, 2014

(51) Int. Cl. G06F 9/455

(52) U.S. Cl. CPC G06F 9/45533

(57) ABSTRACT

Orchestration of a set of sensors selected from a superset of sensors is disclosed. Orchestration can reduce redundant data capture associated with the superset of sensors. Further, selection of sensors for the orchestrated set of sensors can be predicated on the functionality of a sensor, location of a sensor, redundancy of a sensor, etc. Moreover, event measurement information and/or user preference information can be incorporated into the selection of sensors for inclusion in the orchestrated set. Additionally, virtual machine instances can be associated with sensor operation for the orchestrated set of sensors, which can facilitate adaptation of sensor features via the corresponding virtual machine.

### TECHNICAL FIELD

The disclosed subject matter relates to use of a sensor, including sensor virtualization, sensor selection, sensor interaction, sensor adaptation, and employment of a set of sensors.

### BACKGROUND

By way of brief background, sensor proliferation is accelerating and massive numbers of sensors can often be deployed in an area. Often these sensors are deployed with little to no knowledge of other sensors in the same general area. This lack of awareness with regard to other sensors can lead to a silo effect wherein sensor interaction is limited primarily to co-deployed sensors, e.g., sensors that are deployed as part of a sensor system can interact with each other or a controller but generally do not interact with other sensors that are not deployed as part of the sensor system. As such, deployment of sensors that do not facilitate access to sensor features outside of a primary sensor system can be a cause of sensor redundancy and poor sensor coordination. As an example, a traffic camera can be deployed as part of a traffic management system at a location, a security camera for a bank at the same can capture similar image measurements, and a smartphone camera, again at the same location, can also capture similar image measurements; however, where these three image sensors are not coordinated, interaction between the image sensors, or coordinated use of the image sensors, can be unlikely under current sensor technologies. This effect can be magnified by the massive deployment of sensors on everything from wristwatches to refrigerators, from cars to dog collars, etc., where numerous sensors can capture similar measurements of a phenomenon. As such, where sensors remain secluded there is little opportunity to leverage their increasingly ubiquitous nature. Further, where massive numbers of sensors become accessible, the sheer number of sensors can pose significant technical challenges with regard to their effective use.

### BRIEF DESCRIPTION OF DRAWINGS

FIG. 1 is an illustration of a system that facilitates sensor orchestration in accordance with aspects of the subject disclosure.

FIG. 2 is a depiction of a system that facilitates sensor orchestration comprising instantiation of a virtual machine in accordance with aspects of the subject disclosure.

FIG. 3 illustrates a system that facilitates sensor orchestration comprising access to sensor control information in accordance with aspects of the subject disclosure.

FIG. 4 illustrates a system that facilitates sensor orchestration in a generally constrained environment in accordance with aspects of the subject disclosure.

FIG. 5 illustrates a system that facilitates sensor orchestration in an observational environment in accordance with aspects of the subject disclosure.

FIG. 6 illustrates a system that facilitates sensor orchestration in a generally unconstrained environment in accordance with aspects of the subject disclosure.

FIG. 7 depicts a method facilitating sensor orchestration in accordance with aspects of the subject disclosure.

FIG. 8 illustrates a method facilitating sensor orchestration comprising sensor adaptation via a virtual machine instance in accordance with aspects of the subject disclosure.

FIG. 9 depicts a schematic block diagram of a computing environment with which the disclosed subject matter can interact.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Sensors are proliferating and large numbers of sensors can generate measurements of phenomena that can be redundant and poorly coordinated. Often sensors can be deployed with little to no knowledge of other sensors in the same general area. This can lead to a silo effect wherein sensor interaction is limited, e.g., sensors that are deployed as part of a sensor system can interact with each other but generally do not interact with other sensors that are not deployed as part of the sensor system. It can be desirable to deploy sensors that facilitate access to sensor features to a broader audience of users. At an extreme, sensors can be open to any user, although this is unlikely for various economic and political reasons, e.g., a new parent probably does not want their neighbor to be able to access the baby monitor, banks probably don't want potential criminals to have access to bank vault seismic sensors, etc. However, access to sensor features by a wider audience can provide benefits by allowing for coordinated or orchestrated use of sensors. This can reduce redundancy, provide new tools, and leverage sensor data in new ways. Interaction between image sensors, or coordinated use of image sensors, can be unlikely under existing sensor technologies. Massive deployment of sensors on everything from wristwatches to refrigerators, cars to dog collars, sidewalks to parking meters, etc., where numerous sensors can capture similar measurements of a phenomenon, can provide many opportunities to measure events in ways not possible without sensor orchestration. As such, where sensors embrace wider feature access, there is opportunity to leverage their increasingly ubiquitous nature.

Given the increasingly ubiquitous nature of deployed sensors, a degree of redundancy can generally be expected. As an example, at a sporting event there may literally be thousands of closely located image/sound capture devices, accelerometers, temperature sensors, etc., embodied in smartphones in the audience that can generate similar enough measurement data that there is redundancy in the sensor measurement information. While not all of these sensors may produce identical data, they can still be associated with an amount of redundancy in measurement of a phenomenon, e.g., temperature measurements from just a couple smartphones in an area may reasonably represent the temperature in the area without the need to query the temperature from all the smartphones in the area.

In an aspect, some sensors, particularly newer sensors, can be associated with attributes allowing intelligent selection of sensors based on these attributes, e.g., a desired level of performance, a particular type of sensor, a sensor in a particular location, a sensor having sufficient power for a series of measurements, a sensor that is mobile/stationary/movable, a sensor that can be focused/directed/aimed, or nearly any other attribute that can allow for distinction between multiple available sensors. These attributes can be gleaned through an identification of a sensor or sensor model, communication with the sensor such as in a ‘handshake’ communication with the sensor, determined and mapped to a sensor in an area, etc. As an example, where a sensor is deployed that has a particularly good seismic sensor, this information can be published by a source other than the sensor to identify that this attribute is available in the area where the sensor is deployed, the sensor could be queried and respond with identification information or model information allowing the lookup of the attribute, the sensor could directly identify the possessed seismic attribute to other devices, etc. These attributes can provide for distinction between different sensors and can include information related to a sensor type, model, operator, owner, status, condition, range, location, movement, historical aspects, scheduling, availability, cost, provisioning, protocols, rules, deployment date/time, battery life, accuracy, repeatability, error, or nearly any other attribute related to the sensor or operation thereof. It is to be noted that these example attributes do not represent every possible attribute and that all attributes are to be considered within the scope of the instant disclosure though more attributes are not listed for the sake of brevity and clarity.

Sensors can be interacted with via conventional drivers or systems, including hardware and/or software, for example, a thermocouple voltage can be monitored and converted via an algorithm or rule into a corresponding temperature measurement. This type of measurement can be performed with dedicated hardware associated with the sensor, e.g., in a digital thermometer using the example thermocouple an integrated circuit can convert the voltage measurement into an output signal displayed as a temperature on a display of the thermometer. Sensors can also be interacted with via a virtual machine (VM), e.g., a VM can be instantiated on a computing device allowing the VM to receive sensor information and perform a function related to the sensor information. Reusing the prior thermocouple example, an instance of a VM can receive voltage information associated with a thermocouple and can determine a temperature based on the voltage information. Beneficially, instances of VMs can be adapted to adapt the sensor functionality. Continuing the thermocouple example, a linearity can be associated with the thermocouple union type for a given temperature range, the example VM can be tailored to adapt a reported temperature measurement based on the voltage measurement in view of the thermocouple union type.

In an aspect, the use of VMs to interact with sensors can offer an additional advantage in that different instances of VMs can be run in response to an associated sensor. As an example, where there are two different types of thermocouple available, a first VM instance can be run for the first thermocouple and a second VM instance can be run for the second thermocouple. This does not preclude using the same VM instance to interact with either or both thermocouples, however, where each instance of the VM can be tailored to a particular thermocouple type, in this example, running separate instances can provide for tailored interaction with each thermocouple. Continuing the example, where the first thermocouple employs a security layer, the first VM can facilitate access to temperature measurements where the first VM can be validated through the security layer. As another example, where the second thermocouple is associated with an adjustable averaging buffer, the second VM can designate a time value to adjust the averaging of the voltage measurement being reported to the second VM. As such, running tailored VMs that allow interaction with identified attributes of a particular sensor can enable access to a feature that might not otherwise be accessible.

Increasingly, sensors are being deployed that allow for adaptation of an interrogation target of the sensor, e.g., in an electromagnetic sensor particular ranges of frequencies can be interrogated, in an image sensor particular fields of view can be interrogated, an audio sensor array can act as a directional microphone, etc. Sensor orchestration can include interactions with sensors to adapt sensor parameters or features. As an example, an interrogation target can be adapted via sensor orchestration, e.g., an image capture sensor can be adapted to capture images from a particular area of interest, to track a target, to capture only intensity data, to capture only changes in saturation, etc., allowing for a limited repurposing of an already deployed sensor. This can be particularly useful where sensors have redundancy in that redundant sensors can be repurposed to interrogate phenomena at a different level of detail, in a different region, under a different model, or for a different purpose. As an example, where 100 smartphones with microphones are available, repurposing 10 of them to monitor sub 100 Hz sounds, 10 of them to monitor 100 Hz-5 kHz, 10 of them to monitor 5 kHz to 10 kHz, etc., can allow each smartphone to process less data due to the limited frequency range assigned to them, which can allow for faster processing than having all 100 devices monitor the whole audio spectrum. In an aspect, sensor orchestration can comprise features that can be associated with distributed sensing or a distributed sensor. However, sensor orchestration further comprises aspects such as access to nearly any available sensor, selection of appropriate sensors, interaction with sensors via tailored VM instances, adaptation of sensors, etc., that can reduce redundant sensor measurements, provide for coordinated use of deployed sensors, leverage massive sensor deployment effectively, etc.

An orchestrated sensor set can be selected from sensors available in the environment, e.g., deployed sensor that are determined to be available for inclusion in the orchestrated sensor set. Orchestration of the sensors of the orchestrated sensor set can be facilitated by a sensor orchestration component. The sensor orchestration component can be a component of a device or a device in system with access to available sensors. As an example, a sensor orchestration component can be a mobile device component, a NodeB component, a vehicle component, etc. Moreover, the functionality of a sensor orchestration component can be distributed between devices. Further, a sensor orchestration component can be associated with a failover sensor orchestration component(s) to facilitate the failover sensor orchestration component taking up sensor orchestration where the sensor orchestration component is somehow compromised. As an example, a user's tablet computer can comprise a first sensor orchestration component and a smartphone of the user can comprise a second sensor orchestration component, such that, where the tablet computer battery becomes depleted causing the first sensor orchestration component to terminate, the second sensor orchestration component of the smartphone can assume the sensor orchestration as a failover. As a further example, where a sensor orchestration component is operated in a distributed manner between a vehicle computer and a first and second smartphone in the vehicle, shutting off the vehicle and walking away, e.g., removing the vehicle computer from the distributed operation, can result in the distributed sensor orchestration component operation being performed between the first and second smartphones. Continuing this example, where the users of the first and second smartphones then enter their office and separate, the distributed sensor orchestration component can operate on only one of the two smartphones. Further, upon the first smartphone determining that the user's office computer is available, the first smartphone can offload elements to allow distributed sensor orchestration between the office computer and the smartphone. Numerous other examples are readily appreciated and are to be considered within the scope of the instant disclosure despite not being further elucidated here for the sake of clarity and brevity.

Combining the aforementioned aspects can enable orchestrated sensor sets wherein a set of sensors can be selected from sensors of an environment based on sensor attributes and a measurement goal, and the set can be interacted with in a crafted manner responsive to the measurement goal and the attributes of the selected sensors comprising the orchestrated sensor set. This can facilitate inclusion of sensors in the orchestrated sensor set that reduce redundancy while maintaining robustness and relevancy. Further, this can facilitate interaction with sensors of the orchestrated sensor set via targeted VMs to leverage sensor attributes in accord with the measurement goal.

As an example of an orchestrated sensor set, a mobile device can comprise a sensor orchestration component. The sensor orchestration component can receive information indicating a measurement goal related to predicting a severity of an upcoming hurricane season. Measurement goal information can comprise sensor activation or selection information. This sensor activation or selection information, for example, can be based on a hurricane severity prediction model. The model can, for example, designate the types of information needed as model inputs, e.g., historical water temperatures in a geographic area, current water temperatures for the geographic area, prevailing wind speeds at specific altitudes, etc. These measurement goals can be employed to identify sensors relevant to the measurement goal and to reduce redundancy, for example, by selecting hydrotherm sensors in the Gulf of Mexico at a first granularity and hydrotherm sensors off the West coast of Africa at a second granularity. Furthermore, the sensor orchestration component can select hydrotherm sensors associated with a list of government agencies where more than one hydrotherm sensor is available at the designated granularity, e.g., rejecting non-governmental hydrotherm sensors that could be redundant. Moreover, wind speeds can be captured by preferentially selecting sensors on aircraft of major airlines for related flight paths and capturing weather balloon data for relevant but non-flight path areas. Furthermore, where weather balloon data is predicted to become irrelevant due to motion of the balloon in time, the selection of the balloon can reflect the transient nature of the sensor. Additionally, where it is determined that additional data is needed for an area and such sensor data is available in a restricted manner, acquisition of the data can be determined, e.g., where private weather satellite data is available for a cost, the sensor orchestration can apply a rule or a preference to determine if it will access the private weather satellite feed. As an example, where costs are limited to $1 and weather data costs $0.01 per unit, then 100 units of data could be received within the cost limit and the sensor orchestration component can designate 100 units of weather satellite sensor feed in a manner that can meet coverage goals for the region in view of other available sensors, overall cost reduction, speed goals, accuracy goals, or any other designated criterion. As such, rather than interacting with all sensors associated with the relevant geographic areas, a set of sensors can be distinguished and selected from other available sensors of the relevant geographic areas. Further, as illustrated, rules can be designated and employed to adapt the preferential selection of a sensor based on nearly any criteria. These rules can be of any level of complexity and can reflect multiple criteria in determining a selection preference for a sensor.

It will be appreciated that sensors can include dedicated sensors, e.g., sensors dedicated to measurement of a particular phenomenon, multisensors, e.g., a sensor that can measure multiple phenomena, sensor groups, e.g., a set of sensors and/or multisensors for measurement of multiple phenomena, etc. As an example, a dedicated sensor could be a thermocouple, a microphone, a pressure sensor, an electromagnetic transducer, etc. As another example, a multisensory can be a CCTV device that measures both sound, e.g., audio, and images, e.g., video, in an area, etc. Another example can separate a multisensory from a sensor group, wherein a sensor group can be a smartphone having a microphone, an image capture device, electromagnetic sensors, e.g., antennas, etc., accelerometers, temperature sensors, etc. In a sensor group, the several sensors can often be individually employed alone or in groups. This can generally be contrasted with multisensors that typically employ one or more sensors together regardless of how it is employed, for instance, a CCTV as a multisensory will typically always capture both image and sound in contrast to a smartphone that can capture image and sound in some applications, and just sound or images in other applications. It will be noted that a multisensor can also include a single sensor that measures a plurality of phenomena, in contrast to a sensor group that will typically comprise a plurality of sensors in a device or component. In some embodiments, a device can represent both a multisensor and a sensor group simultaneously.

In an embodiment, a system can perform operations comprising receiving sensor information about a sensor device and determining a set of sensors wherein the set of sensors is employed in capturing event information related to an event. Further, an instance of a virtual machine can interact with the sensor device of the set of sensors enabling adaptation of a sensor function via the virtual machine. The system can further facilitate access to event information captured by the sensor device.

In another embodiment, a method can comprise receiving sensor information about a sensor device deployed in an environment. Further, event information associated with an event can be received. The method further comprises determining a set of sensors comprising the sensor device based on the sensor information and the event information, wherein the set of sensors facilitates measuring the phenomenon related to the event. An instance of a virtual machine further enables adapting of a sensor function of the sensor device. The method also enables access to measurement information related to the measuring the phenomenon facilitated by the set of sensors.

Moreover, in further embodiment, a computer readable storage device can cause a system to receive sensor information about a sensor device associated with an environment and determining a set of sensors comprising the sensor device. The set of sensors can be employed in capturing event information. Further, a virtual machine instance to interact with the sensor device of the set of sensors can cause adaptation of a sensor function of the sensor device. Access to the event information captured by the sensor device can then be facilitated.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

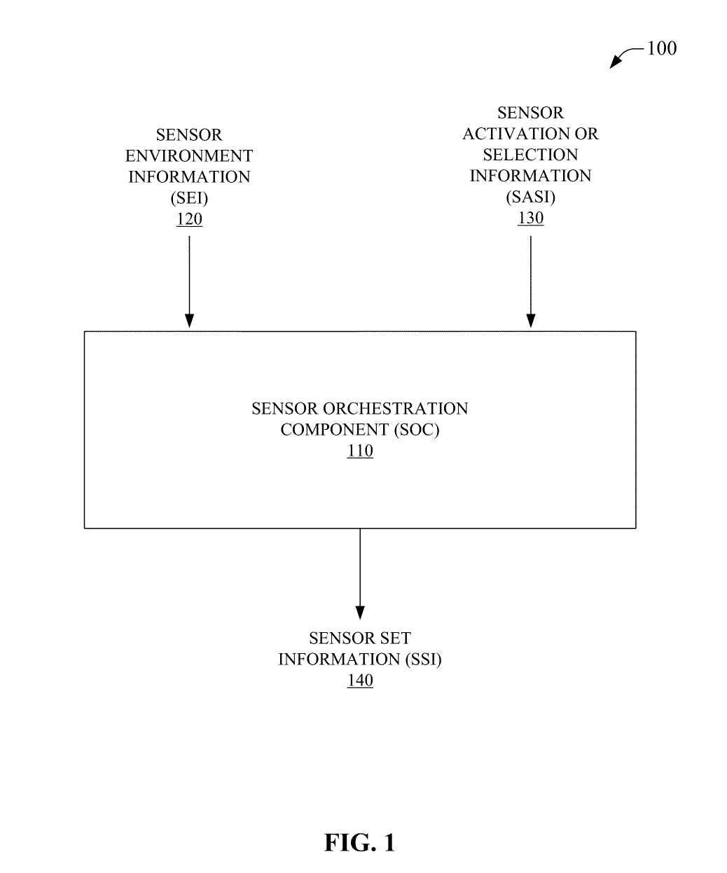

FIG. 1 is an illustration of a system 100, which facilitates sensor orchestration in accordance with aspects of the subject disclosure. System 100 can include sensor orchestration component (SOC) 110. SOC 110 can facilitate sensor orchestration based on information pertaining to available sensors and a criterion related to sensor selection of activation. As such, SOC 110 can receive sensor environment information (SEI) 120 that can comprise information about an available sensor in an environment. In an aspect, SEI 120 can comprise a list of available sensors for an environment, identification information for a sensor in the environment, feature information for a sensor in the environment, measurement information from a sensor in the environment, etc. It will be noted that nearly any information pertaining to a sensor or operation of a sensor in an environment can be included in SEI 120 and that all such information is considered within the scope of the instant disclosure. SEI 120 can facilitate learning about what sensors are in an environment, what their capabilities are, how to interact with the sensor, the status or availability of the sensor to be included in an orchestrated sensor set, a sensor pedigree, sensor conditions, etc. This information can be employed to determine aspects of a sensor or operation thereof that can be employed in determining if the sensor is to be included in an orchestrated sensor set. In certain embodiments, SEI 120 can facilitate ranking of a plurality of sensors from an environment on one or more characteristics or features that can enable directed selection of particular sensors to comprise an orchestrated sensor set. In environments with pluralities of available sensors, this aspect can allow selection of none, some, or all sensors of the environment for inclusion in the orchestrated sensor set. Further, where there is a large plurality of sensors in an environment, it can be expected that the most appropriate sensors can be selected for inclusion in the orchestrated sensor set based on selection rules or algorithms that can query received SEI 120 in view of selection or activation criteria.

SOC 110 can further receive sensor activation or selection information (SASI) 130 that can comprise a selection or activation criterion. SASI 130 can be employed, in conjunction with SEI 120, by SOC 110 to select a sensor in an environment for inclusion in an orchestrated sensor set. In an embodiment, SASI 130 can comprise a preference, e.g., a user preference, related to sensor selection. As an example, a preference can indicate that sensor selection should prefer no-cost sensor access such that where two otherwise similar sensors are available the no-cost sensor will be selected over a sensor that is associated with an access cost such as a fee or access reciprocity. In another embodiment, SASI 130 can comprise an event or trigger information that can aid in selection of an appropriate sensor from an environment. As an example, event information can indicate a type of sensor to be selected, e.g., measurement of seismic events can preferentially select seismic sensors but can also select image sensors where the image data can be analyzed for motion related to a seismic event, or could also select audio sensors capable of measuring sufficiently low frequencies to capture audio signatures of seismic events. As another example, trigger information can be related to selection of sensors based on triggering speed, location, probability of continued relevance as a function of time, type of sensor, etc., such as, selecting sensors within about 10 meters on either side of a marathon running course to allow data capture along the course rather than selecting all sensors within 13.1 mile radius of a center point of the race course, which would likely include a much larger geographic area and a large number of low relevance sensors.

SOC 110 can facilitate access to sensor set information (SSI) 140 that can comprise a list of sensors comprising an orchestrated sensor set. SSI 140, in certain embodiments, can also comprise measurement information from sensors of an orchestrated sensor set. In further embodiments, SSI 140 can comprise sensor interaction information, e.g., communication protocols, control signaling, network credentials, etc., for sensors of an orchestrated sensor set. As such, in an embodiment, SSI 140 can comprise information about the sensors of an orchestrated sensor set allowing other components to initiate contact with the sensors of the orchestrated sensor set. In other embodiments, SSI 140 can comprise actual sensor measurement information. Further, in some embodiments, SSI 140 can comprise sensor control and access information to facilitate sensor measurement data being accessible by another component and further facilitating sensor adaptation by another component. In some embodiments, SSI 140 can enable SOC 110 to interact with and/or adapt sensor features of a sensor of an orchestrated sensor set, e.g., via a VM, while also facilitating access to measurement data from the sensor of the orchestrated sensor set.

System 100 can be particularly useful where large numbers of sensors are deployed in an environment by allowing inclusion of a sensor in an orchestrated sensor set based on SEI 120 and SASI 130 and further facilitating interaction with the sensor via SSI 140. As an example, where SEI 120 indicates that there are 25,000 accelerometer sensors based in vehicles, smartphones, and wearable devices, on a portion of freeway, a certain number of these sensors are likely to generate redundant motion data, e.g., where a vehicle has an accelerometer, the driver is wearing a device comprising an accelerometer, and a passenger has a smartphone with an accelerometer, these devices are likely to generate somewhat redundant accelerometer data based on the movement of the vehicle. SASI 130 can indicate that sensors are to be preferentially selected with a granularity of 30 feet between sensors and should report data only when motion changes by more than 10% per second. SASI 130 from this example can be coupled with SEI 120 to select only one of the three accelerometers in the example vehicle because the three sensors are within 30 feet of each other. Further, the one accelerometer that can be selected can be based on the preference for selective reporting, e.g., where the wearable device lacks significant processing power it may not be adaptable to only report out data when there is a 10% change per second, however both the smartphone and the vehicle accelerometers may be capable of this feature. The selection between the smartphone and vehicle can then be based on other aspects, such as preferentially selecting the vehicle accelerometer since it is less likely to include motion measurements such as moving the smartphone within the vehicle, preferentially selecting the vehicle accelerometer based on a more reliable power supply or higher transmission power, preferentially selecting the smartphone based on a user preference, etc. This illustrates that an orchestrated sensor set can reduce redundancy of sensors which can be associated with lower data transport burdens and/or costs, improved battery life, etc. Further, these examples illustrate intelligent selection and use of sensor resources from an environment, which can be associated with selection of the best sensor(s) for a task, collaborative use of sensors in an environment, improved resource optimization, adaptation of a sensor feature(s), etc.

In an embodiment, SOC 110 can coordinate sensor use for a plurality of sensors comprising an orchestrated sensor set. This coordination between disparate sensors of the orchestrated sensor set can comprise coordination between instances of VMs associated with the several sensors of the orchestrated sensor set. Wherein a VM can facilitate interaction with a sensor, such as via, SSI 140, coordination between VM instances can facilitate coordination between a plurality of sensors to leverage these several sensors' features to act as a more comprehensive sensor or perhaps a distributed sensor. As an example, several mobile devices with microphones can act as a distributed conference call microphone where they are present in a conference room and are selected for inclusion in an orchestrated sensor set. VM instances can be instantiated for interaction with the individual microphones comprising the orchestrated sensor set. These separate VM instances can adapt each microphone to report measured signals having a volume above a determined level, which can be associated with a user voice closer to that microphone than other voices, in contrast to the more typical operation of reporting all measured sound. Moreover, the several VM instances can interact, for example, to adjust the determined level based on which microphones are reporting signals simultaneously, e.g., where three microphones are reporting a signal simultaneously, the threshold volume can be increased so that only one microphone reports a signal. As another example, several image capture sensors can be aimed based on interaction between the VM instances associated with the individual image capture sensors, such as aiming a CCTV camera at the same location from different angles, aiming CCTV cameras at successive areas to effect a ‘panoramic’ image capture, aiming CCTV cameras to capture blind spots in other image captures, aiming CCTV cameras to track a moving object intelligently based on knowledge of the range of each of the several CCTV cameras in an orchestrated sensor set, etc.

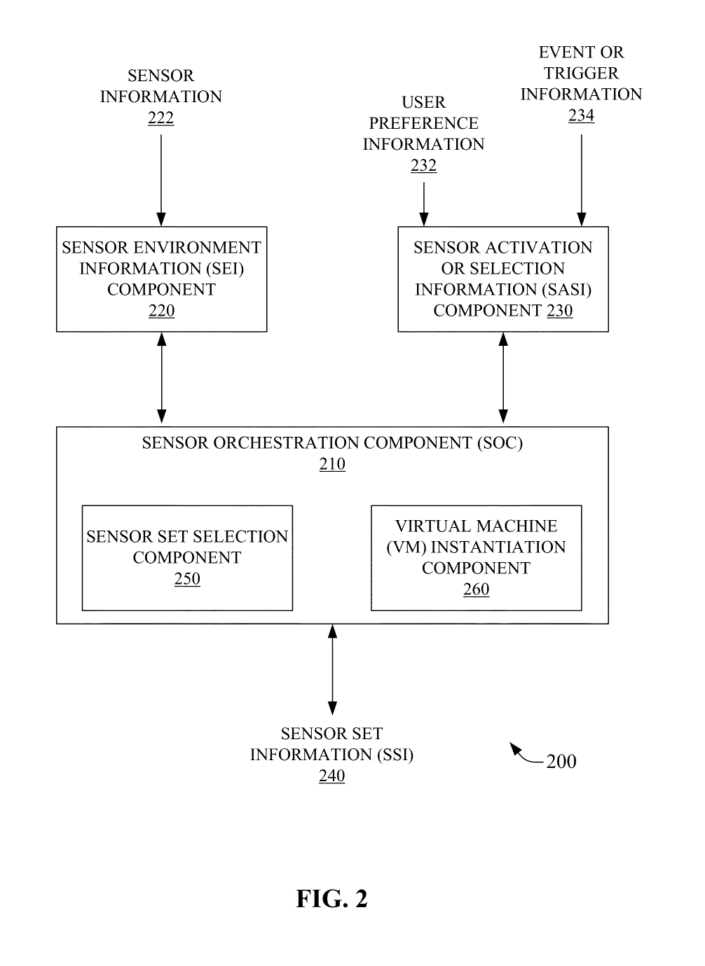

FIG. 2 is a depiction of a system 200 that can facilitate sensor orchestration comprising instantiation of a virtual machine in accordance with aspects of the subject disclosure. System 200 can include sensor orchestration component (SOC) 210, which can facilitate sensor orchestration. SOC 210 can receive sensor information 222 via sensor environment information (SEI) component 220. Sensor information 222 that can comprise information related to a sensor in an environment. In an aspect, sensor information 222 can comprise a list of sensors for an environment, identification information for a sensor in the environment, feature information for a sensor in the environment, measurement information from a sensor in the environment, etc. Additionally, SEI component 220 can facilitate gathering information from sources other than sensor information 222 with regard to what sensors are in an environment, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set.

SEI 220 can facilitate ranking of a plurality of sensors from an environment based on one or more characteristics or features that can enable intelligent selection of particular sensors to comprise an orchestrated sensor set. In environments with pluralities of available sensors, this aspect can allow selection of none, some, or all sensors of the environment for inclusion in the orchestrated sensor set. Further, where there is a large plurality of sensors in an environment, it can be expected that highly ranked sensors can be selected for inclusion in the orchestrated sensor set over lower ranked sensor. Ranking can be based on selection rules or algorithms applied to SEI received at SEI component 220.

SOC 210 can further receive information relating to a selection or activation criterion, via sensor activation or selection information (SASI) component 230, that can comprise user preference information 232 and/or event or trigger information 234. SASI component 230 can be employed, in conjunction with SEI component 220, by SOC 210 to select a sensor in an environment for inclusion in an orchestrated sensor set. In an embodiment, SASI component 230 can receive user preference information 232 that can relate to preferences in sensor selection. As examples, a preference can indicate that sensor selection should preferentially select sensors associated with an identified mobile network provider, sensors having favorable peer reviews, sensors that are recently calibrated, etc. In another embodiment, SASI component 230 can receive event or trigger information 234 that can aid in selection of an appropriate sensor from an environment. As an example, event or trigger information 234 can facilitate determining a type of sensor to be selected, e.g., events that are enabled by tracking a moving object can preferentially select sensors that can be aimed, steered, or otherwise directed to track the moving object, such as adjusting a CCTV to follow an individual, beam forming to track a moving radio device, selecting a series of sensors along a predicted route, etc. As another example, event or trigger information 234 can be related to selection of sensors based on triggering speed, location, probability of continued relevance as a function of time, type of sensor, etc.

SOC 210 can further comprise sensor set selection component 250 that can facilitate selection of sensors included in an orchestrated sensor set and selected from sensors of an environment based on SEI and SASI. In an embodiment, sensor set selection component 250 can select a sensor based on a rule that reflects a SASI criterion and considers aspects and features of a sensor of the environment. This rule can be determined by sensor set selection component 250 or can bereaved from another component by sensor set selection component 250. Moreover, sensor set selection component 250 can apply one or more rules. Further, a rule can be updated or adapted.

SOC 210 can also comprise VM instantiation component 260 to facilitate interaction with a sensor of an orchestrated sensor set. VM instantiation component 260 can instantiate one or more instances of VMs. These VMs can be employed to interact with one or more sensors. Further, VM instantiation component 260 can instantiate tailored VMs that enable access to specialized features of certain sensors and/or adaptation of sensor features. In an embodiment, VM instantiation component 260 can facilitate coordinated sensor use for a plurality of sensors comprising an orchestrated sensor set. Coordination between disparate sensors of the orchestrated sensor set can comprise coordination between different instances of VMs associated with the several sensors of the orchestrated sensor set. In an embodiment, the use of VM instances, via VM instantiation component 260, for interaction with sensors can enable SOC 210 rapidly and dynamically to interact with a plurality of arbitrarily selected sensors by simply accessing a library of VMs and selecting an appropriate VM for an available sensor. Thus, changes in sensors comprising the orchestrated set can quickly be accommodated by instantiating another appropriate VM as a sensor is added to the set, the SASI criteria change, etc. Similarly, where a sensor is removed from the orchestrated set, the corresponding VM instance can be terminated to free up resources. Moreover, a sensor can be associated with more than one VM depending on the use of the sensor, sensor features, or available resources, for example, where SOC 210 has limited processor resources, VM instantiation component 260 can employ VMs that each interact with more than one sensor to reduce processor overhead that can be associated with higher numbers of VMs.

Further, SOC 210 can facilitate access to sensor set information (SSI) 240 that can comprise a list of sensors comprising an orchestrated sensor set. SSI 240, in certain embodiments, can also comprise measurement information from sensors of an orchestrated sensor set. In some embodiments, SSI 240 can comprise sensor interaction information, e.g., communication protocols, control signaling, network credentials, etc., for sensors of an orchestrated sensor set. As such, SSI 240 can comprise information, for example, about the sensors of an orchestrated sensor set allowing other components to initiate contact with the sensors of the orchestrated sensor set, actual sensor measurement information, or sensor control and access information to facilitate sensor measurement data being accessible by another component and further facilitating sensor adaptation by another component. In some embodiments, SSI 240 can enable SOC 210 to interact with and/or adapt sensor features of a sensor of an orchestrated sensor set while also facilitating access to measurement data from the sensor of the orchestrated sensor set.

Where a plurality of sensors are deployed in an environment, system 200 can allow inclusion of a sensor in an orchestrated sensor set based on SEI and SASI and further facilitate interaction with the sensor via SSI 240. As such, an orchestrated sensor set can reduce sensor redundancy which can lower data transport burdens and/or costs, improved battery life, etc. Further, intelligent selection and use of sensor resources can be associated with selection of the best sensor(s) for a task, collaborative use of sensors in an environment, improved resource optimization, adaptation of a sensor feature(s), etc.

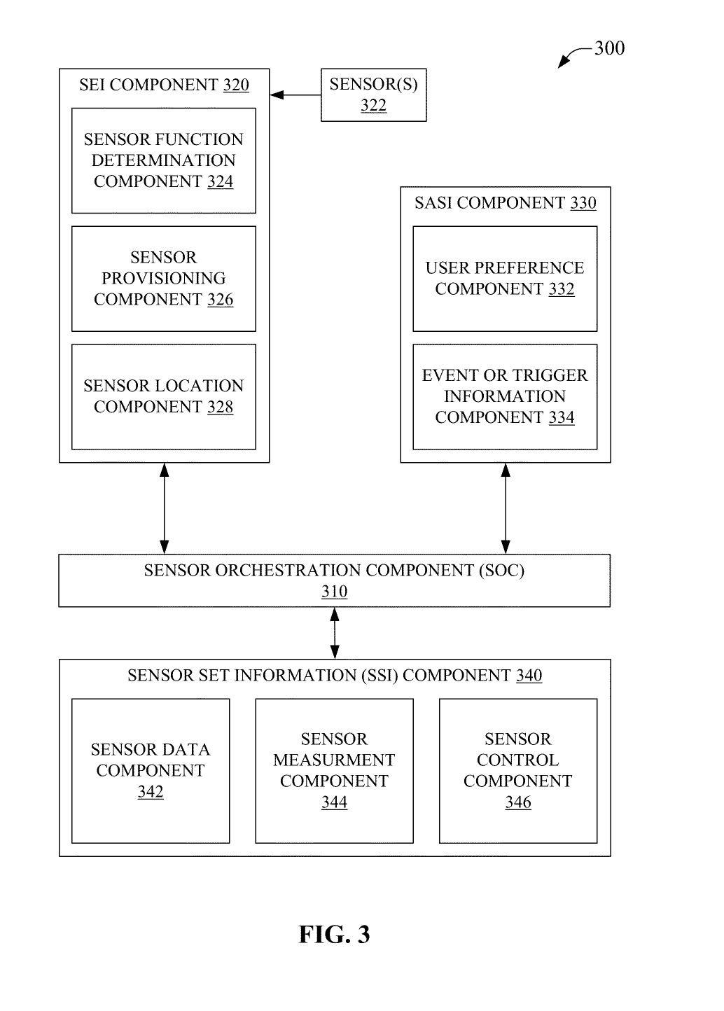

FIG. 3 illustrates a system 300 that facilitates sensor orchestration comprising access to sensor control information in accordance with aspects of the subject disclosure. System 300 can include sensor orchestration component (SOC) 310 that can facilitate sensor orchestration and access to sensor control information. SOC 310 can receive information from sensor(s) 322 via sensor environment information (SEI) component 320. Information from sensor(s) 322 can comprise information related to operation of sensor(s) 322, data from sensor(s) 322, or other information related to sensor(s) 322. In an aspect, information from sensor(s) 322 can comprise a list of sensor(s) 322 for an environment, identification information for sensor(s) 322 in the environment, feature information for sensor(s) 322 in the environment, measurement information from sensor(s) 322 in the environment, etc. Additionally, SEI component 320 can facilitate gathering information from sources other than sensor(s) 322 with regard to what sensor(s) 322 are in an environment, what sensor(s) 322 features/capabilities are, how to interact with sensor(s) 322, the status or availability of sensor(s) 322 to be included in an orchestrated sensor set, sensor(s) 322 pedigree(s), sensor(s) 322 conditions, etc. This information can be employed to determine aspects of sensor(s) 322, or operation thereof, which can be employed in determining if sensor(s) 322 is to be included in an orchestrated sensor set.

SEI component 320 can facilitate ranking of a plurality of sensors from an environment, e.g., sensor(s) 322, based on one or more characteristics or features that can enable intelligent selection of particular sensors to comprise an orchestrated sensor set. In environments with pluralities of available sensors, this aspect can allow selection of none, some, or all sensors of the environment for inclusion in the orchestrated sensor set. SEI component 320 can comprise sensor function determination component 324 that can determine a function of sensor(s) 322. This can facilitate determinations related to including sensor(s) 322 in an orchestrated sensor set. This can also facilitate selection of a VM instance via SOC 310 for interaction with sensor(s) 322 that are included in an orchestrated sensor set. SEI component 320 can further comprise sensor provisioning component 326 that can enable provisioning of a sensor included in an orchestrated sensor set. Sensor provisioning component 326 can communicate with a VM instance to facilitate provisioning of a sensor. In an aspect, provision can allow a sensor to adopt settings, for example, allowing the sensor to act as a device associated with a proprietary system, e.g., a sensor can be provisioned differently to allow it to act with a first wireless provider proprietary system in one instance and with a second, non-compatible, wireless provider proprietary system in another instance. SEI component 320 can additionally comprise sensor location component 328 that can facilitate determining a sensor location. Sensor location can facilitate determination of sensor movement and can further facilitate determining a predicted future location or movement. As such, sensor location component 328 can aid in determining if a sensor is likely to remain relevant, for example, if a sensor is located in a moving vehicle headed away from an event, at some time it is likely to become an irrelevant sensor and can be removed from an orchestrated sensor set.

SOC 310 can further receive information relating to a selection or activation criterion, via sensor activation or selection information (SASI) component 330, that can comprise user preference component 332 and/or event or trigger information component 334. SASI component 330 can be employed, in conjunction with SEI component 320, by SOC 310 to select a sensor in an environment, e.g., sensor(s) 322, for inclusion in an orchestrated sensor set. In an embodiment, SASI component 330 can receive user preference information via user preference component 332 to influence sensor selection. A preference can indicate that sensor selection should preferentially select sensors, for example, having high accuracy and measurement reproducibility, sensors having certain features, sensors that are environmentally friendly, etc. In another embodiment, SASI component 330 can receive selection information via event or trigger information component 334 that can aid in selection of an appropriate sensor from an environment based on, for example, a type of sensor to be selected, triggering speed, location, probability of continued relevance as a function of time, etc.

SOC 310 can select a sensor based on a rule that reflects a SASI criterion and considers aspects and features of a sensor of the environment. This rule can be determined by SOC 310 or can be received from another component. A rule can be updated or adapted. SOC 310 can apply one or more rules as part of selecting a sensor for inclusion. SOC 310 can also instantiate one or more instances of a VM. These VMs can be employed to interact with one or more sensors. Further, VM instantiation can run tailored VMs that enable access to specialized features of certain sensors and/or adaptation of sensor features. In an embodiment, SOC 310 can facilitate coordinated sensor use for a plurality of sensors comprising an orchestrated sensor set. Coordination between disparate sensors of the orchestrated sensor set can comprise coordination between different instances of VMs associated with the several sensors of the orchestrated sensor set. In an embodiment, the use of VM instances for interaction with sensors can enable SOC 310 rapidly and dynamically to interact with a plurality of arbitrarily selected sensors by simply accessing locally or remotely stored VMs to select an appropriate VM for an available sensor. Changes in sensors comprising the orchestrated set can thereby be quickly accommodated.

System 300 can further comprise sensor set information (SSI) component 340 that can enable access to information related to the orchestrated sensor set. SSI component 340 can comprise sensor data component 342, sensor measurement component 344, and sensor control component 346. Sensor data component 342 can enable access to data related to a sensor of an orchestrated sensor set, such as a list of sensors comprising the orchestrated sensor set, features of sensors comprising the orchestrated sensor set, etc. Sensor measurement component 344 can facilitate access to measurement information from sensors of an orchestrated sensor set. This measurement information can comprise raw data, processed data, information derived from sensor measurement of a phenomenon, etc. In an aspect, sensor data component 342 can relate information about the sensor or its operation condition while sensor measurement component 344 can relate data related to an aspect sensed or measured by the sensor. Sensor control component 346 enables access to sensor interaction information, e.g., communication protocols, control signaling, network credentials, etc., for sensors of an orchestrated sensor set. Sensor control component 346 can comprise information closely associated with a VM instantiated by SOC 310. In some embodiments, SSI component 340 can enable SOC 310 to interact with and/or adapt sensor features of a sensor of an orchestrated sensor set, via sensor control component 346, while also facilitating access to measurement data, e.g., 344, and sensor data, e.g., 342, from the sensor, e.g., sensor(s)322, of the orchestrated sensor set.

Where a plurality of sensors are deployed in an environment, system 300 can allow inclusion of sensor(s) 322 in an orchestrated sensor set based on SEI and SASI and further facilitate interaction with the sensor via SSI 340. As such, an orchestrated sensor set can reduce sensor redundancy which can lower data transport burdens and/or costs, improved battery life, etc. Further, intelligent selection and use of sensor resources can be associated with selection of a most appropriate sensor(s) for a task, collaborative use of sensors in an environment, improved resource optimization, adaptation of a sensor feature(s), etc.

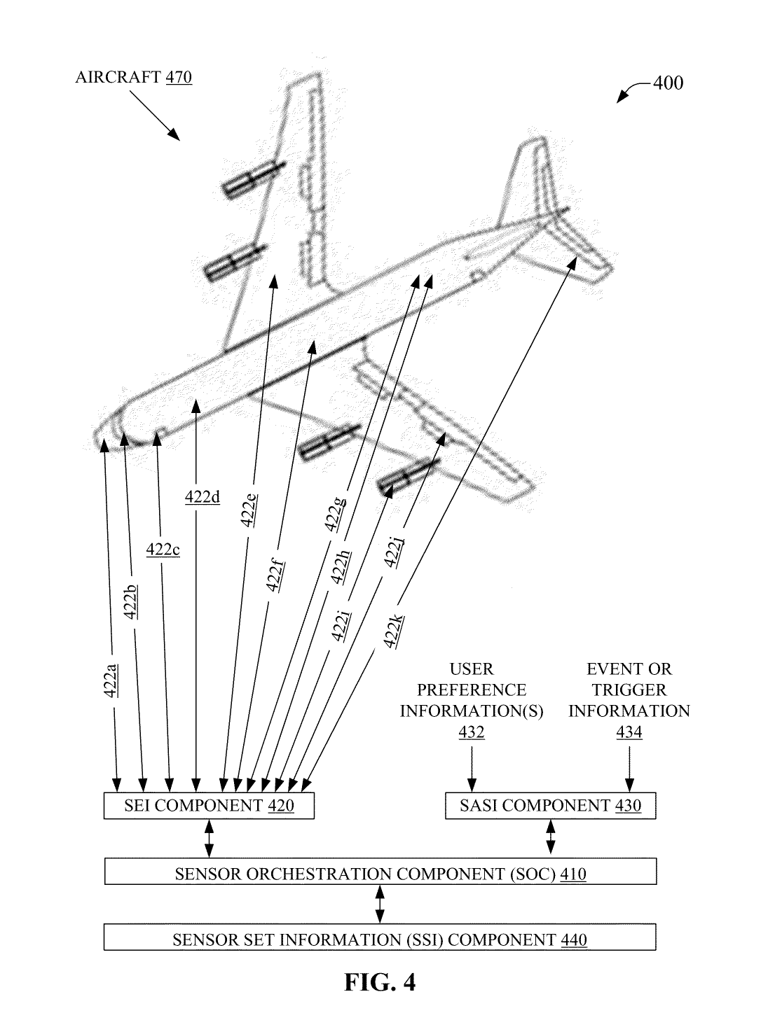

FIG. 4 illustrates example system 400 that facilitates sensor orchestration in a generally constrained environment in accordance with aspects of the subject disclosure. System 400 can include a generally constrained environment such as airliner 470. A generally constrained environment implies that sensors of the environment are typically constrained in some manner, such as by a boundary condition, a regulatory condition, etc. As an example, airliner 470 is generally constrained in that typically all sensors will be located on or within the envelope of the aircraft. The modifier ‘generally’ is included so as not to exclude atypical conditions such as a towed sensor trailing behind aircraft 470, or sensors perhaps in close proximity where another aircraft may be flying in formation with aircraft 470. Similarly, by example, a ship, a car, a hot air balloon, an island, an oasis surrounded by vast desert, etc. can all fall within the umbrella of a generally constrained environment. Moreover, conditions such as electronically isolated environments, perhaps a missile installation, a high security government facility or military base, a secure corporate research facility, or the like could also be considered generally constrained environments because of an imposed segregation constraining sensors as compared to a physical constraint as in airliner 470.

System 400 can include sensor orchestration component (SOC) 410. SOC 410 can facilitate sensor orchestration from a constrained environment, such as airliner 470, based on information pertaining to available sensors and a criterion related to sensor selection of activation. As such, SOC 410 can receive sensor information via environment information (SEI) component 420. Sensor information can comprise information about a sensor of, or related to, aircraft 470. In an aspect, SEI component 420 can enable access to sensor information that can comprise, for example, a list of available sensors of or in aircraft 470, identification information for a sensor of or in aircraft 470, feature information for a sensor of or in aircraft 470, measurement information from a sensor of or in aircraft 470, etc. It will be noted that nearly any information pertaining to a sensor or operation of a sensor of or in aircraft 470 can be accessed via SEI component 420 and that all such information is considered within the scope of the instant disclosure. SEI component 420 can facilitate learning about what sensors are associated with aircraft 470, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set. In certain embodiments, SEI component 420 can facilitate ranking of a plurality of sensors associated with aircraft 470 based on one or more characteristics or features that can facilitate selection of particular sensors to comprise an orchestrated sensor set. An orchestrated sensor set can comprise none, some, or all sensors associated with aircraft 470. Further, where there is a large plurality of sensors in an environment, it can be expected that the most appropriate sensors can be selected for inclusion in the orchestrated sensor set based on selection rules or algorithms applied by SOC 410.

SOC 410 can further receive selection criteria via sensor activation or selection information (SASI) component 430. SASI component 430 can be employed, in conjunction with SEI component 420, by SOC 410 to facilitate selecting a sensor associated with aircraft 470 for inclusion in an orchestrated sensor set. In an embodiment, SASI component 430 can receive preference information, e.g., user preference information 432, related to sensor selection. In another embodiment, SASI component 430 can receive event or trigger information 434 that can aid in selection of an appropriate sensor from those associated with aircraft 470.

SOC 410 can be coupled to sensor set information (SSI) component 440 that can facilitate access to information related to sensors comprising an orchestrated sensor set. SSI component 440, in certain embodiments, can also enable access to measurement information from sensors of an orchestrated sensor set. In further embodiments, SSI component 440 can facilitate access to sensor interaction information. In some embodiments, SSI component 440 can enable SOC 410 to interact with and/or adapt sensor features of a sensor of an orchestrated sensor set, e.g., via a VM, while also facilitating access to measurement data and sensor data from the sensor of the orchestrated sensor set. An orchestrated sensor set can reduce redundancy of sensors which can be associated with lower data transport burdens and/or costs, improved battery life, etc. Further, intelligent sensor selection and coordinated use of sensor resources from an environment can be associated with selection of the best sensor(s) for a task, collaborative use of sensors in an environment, improved resource optimization, adaptation of a sensor feature(s), etc.

In an embodiment, SOC 410 can coordinate sensor use for a plurality of sensors comprising an orchestrated sensor set. This coordination between disparate sensors of the orchestrated sensor set can comprise coordination between instances of VMs associated with the several sensors of the orchestrated sensor set. Wherein a VM can facilitate interaction with a sensor, such as via SSI component 440, coordination between VM instances can facilitate coordination between a plurality of sensors. As illustrated, multiple sensors of aircraft 470 or within aircraft 470 can communicate with SEI component 420. SEI component 420 can receive information related to sensors of aircraft 470 such as radar sensors information 422a, cockpit sensor information 422b, cabin portal status information 422c, wing pressure sensor information 422e, engine sensor information 422i, control surface information 422j and 422k, etc. Further, additional information can be available from sensors within airliner 470 that are not sensors deployed as part of the plane itself, such as accelerometer information from a mobile device in a first class cabin 422d, cabin pressure measurements from a wearable device on a passenger located in the middle of the plane 422f, accelerometer information from the rear of the plane at 422g and 422h. The information feeds from these sensors of or in aircraft 470 can be selected for inclusion in an orchestrated sensor set. It is noted that some sensors may not be made available to the general public. Therefore, an orchestrated sensor set initiated by a device of aircraft 470 can include different sensors that might be found in an orchestrated sensor set initiated by a device of a passenger on aircraft 470. As an example, a communications protocol can include security features that are navigable by aircraft 470 operators but are not navigable by a passenger. Sensor inclusion in a first orchestrated sensor sets does not preclude inclusion of the sensor in other orchestrated sensor sets except to the extent that the use in the first set is incompatible with use in the second set, for example, where a CCTV camera would be tasked with being aimed in opposing directions simultaneously.

SOC 410 can act as a distributed “black box” allowing a device to access and/or store data from numerous sensors throughout the constrained environment. Moreover, where multiple devices of or in aircraft 470 comprise a SOC 410, each device can access and/or store sensor data. In an aspect, each of the multiple devices having an SOC 410 can capture the same sensor data. However, in another aspect, each of the multiple devices having an SOC 410 can capture at least some sensor data that is not the same and, in some embodiments, each of the multiple devices captures only different data. This aspect can parallel RAID designs in data storage systems such that completely duplicated data is similar to a RAID-0 store, while storing some different data can be akin to RAID striping, etc. In effect, were aircraft 470 to experience an event, distribution of sensor data across multiple devices can provide for alternative access to this information in addition to the conventional black boxes. As an example, a passenger laptop at 422h, and simultaneously an MP3 player at 422d, could store a cockpit voice recording from 422b, along with control surface information from 422j and 422k. This can provide an alternative recording supplemental to the conventional black box.

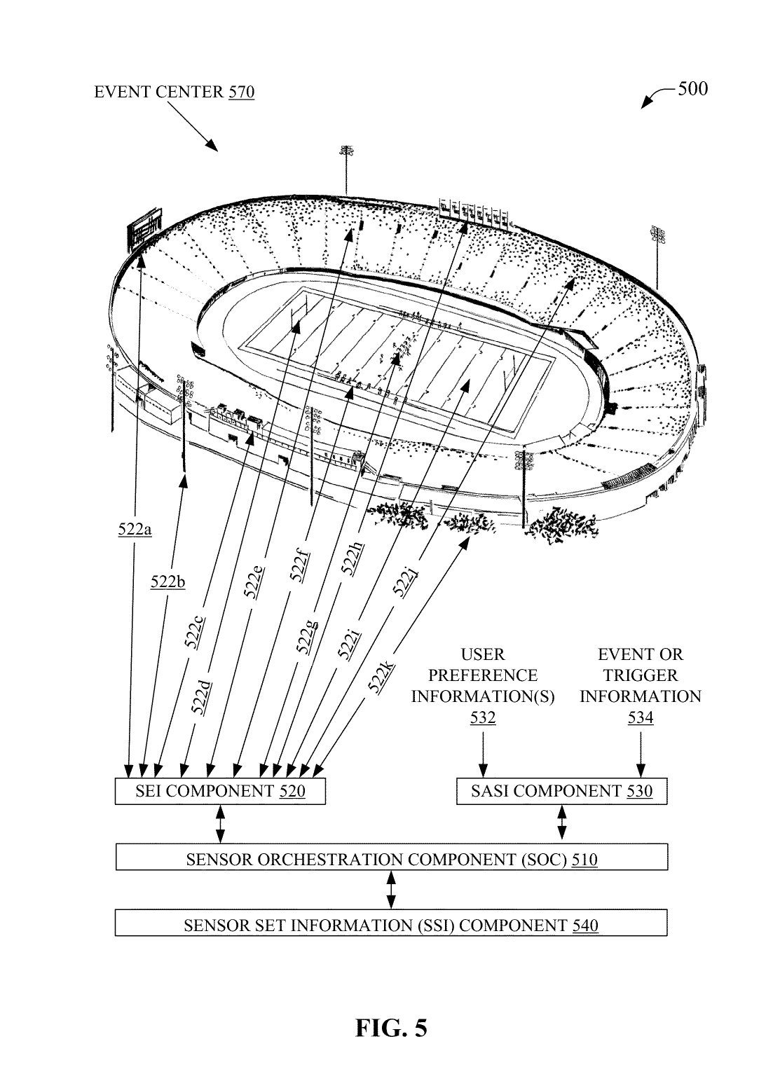

FIG. 5 illustrates example system 500 that facilitates sensor orchestration in an observational environment in accordance with aspects of the subject disclosure. System 500 can an observation environment such as event center 570, e.g., for a sporting event, concert, rally, etc. System 500 can include sensor orchestration component (SOC) 510. SOC 510 can facilitate sensor orchestration in an observational environment, such as event center 570, based on information pertaining to available sensors and a criterion related to sensor selection of activation. As such, SOC 510 can receive sensor information via environment information (SEI) component 520. Sensor information can comprise information about a sensor associated with event center 570. In an aspect, SEI component 520 can enable access to sensor information that can comprise, for example, a list of available sensors associated with event center 570, identification information for a sensor associated with event center 570, feature information for a sensor associated with event center 570, measurement information from a sensor associated with event center 570, etc. It will be noted that nearly any information pertaining to a sensor or operation of a sensor associated with event center 570 can be accessed via SEI component 520 and that all such information is considered within the scope of the instant disclosure. SEI component 520 can facilitate learning about what sensors are associated with event center 570, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set. In certain embodiments, SEI component 520 can facilitate ranking of a plurality of sensors associated with event center 570 based on one or more characteristics or features that can facilitate selection of particular sensors to be included in an orchestrated sensor set. An orchestrated sensor set can comprise none, some, or all sensors associated with event center 570. Further, where there is a large plurality of sensors in an environment, it can be expected that the most appropriate sensors can be selected for inclusion in the orchestrated sensor set based on selection rules or algorithms applied by SOC 510.

SOC 510 can receive selection criteria via sensor activation or selection information (SASI) component 530. SASI component 530 can be employed, in conjunction with SEI component 520, by SOC 510 to facilitate selecting a sensor associated with event center 570 for inclusion in an orchestrated sensor set. In an embodiment, SASI component 530 can receive preference information, e.g., user preference information 532, related to sensor selection. In another embodiment, SASI component 530 can receive event or trigger information 534 that can aid in selection of an appropriate sensor from those associated with aircraft 570.

SOC 510 can be coupled to sensor set information (SSI) component 540 that can facilitate access to information related to sensors comprising an orchestrated sensor set. SSI component 540, in certain embodiments, can also enable access to measurement information from sensors of an orchestrated sensor set. In further embodiments, SSI component 540 can facilitate access to sensor interaction information. In some embodiments, SSI component 540 can enable SOC 510 to interact with and/or adapt sensor features of a sensor of an orchestrated sensor set, e.g., via a VM, while also facilitating access to measurement data and sensor data from the sensor of the orchestrated sensor set. An orchestrated sensor set can reduce redundancy of sensors which can be associated with lower data transport burdens and/or costs, improved battery life, etc. Further, intelligent sensor selection and coordinated use of sensor resources from an environment can be associated with selection of the best sensor(s) for a task, collaborative use of sensors in an environment, improved resource optimization, adaptation of a sensor feature(s), etc.

In an embodiment, SOC 510 can coordinate sensor use for a plurality of sensors comprising an orchestrated sensor set. This coordination between disparate sensors of the orchestrated sensor set can comprise coordination between instances of VMs associated with the several sensors of the orchestrated sensor set. Wherein a VM can facilitate interaction with a sensor, such as via SSI component 540, coordination between VM instances can facilitate coordination between a plurality of sensors. As illustrated, multiple sensors associated with event center 570 can communicate with SEI component 520. SEI component 520 can receive information related to these sensors, such as wind sensor information 522a, lighting status sensor information 522b, temperature sensor information 522c, scoring sensor information 522d, sound pressure sensor information 522e, sidelined player physiology sensor information 522f, active player physiology sensor information 522g, image sensor information 522h, vibration sensor information 522i, sound pressure sensor information 522j, sound pressure sensor information 522k, etc. The information feeds from these sensors can be selected for inclusion in an orchestrated sensor set. It is noted that some sensors may not be made available to the general public. Hence, different orchestrated sensor sets can comprise different sensors. Sensor inclusion in a first orchestrated sensor sets does not necessarily preclude inclusion of the sensor in other orchestrated sensor sets. It can be readily observed that a player trainer can provide user preferences, e.g., 532, and trigger information, e.g., 534, such that an orchestrated sensor set can provide valuable insight into player performance, such as synchronizing an active player's physiology (522g) against image captures (522h) and environmental conditions (522a, b) which can then be employed as a baseline in determining recovery by monitoring sideling player physiology (522f). In this example, the remaining sensor information would be extraneous and the associated sensors would not be included in the orchestrated sensor set despite being otherwise available. In contrast, a sports writer may want to access all of the sensors that are not redundant, e.g., where sound pressure is redundant 522e and j, it is possible only one of the two sensors can be selected. This can allow the sports writer to address different angles to a story related to the sporting event, such as, was wind speed (522a) and player fatigue (522g) a factor when a field goal was missed (522c), or was crowd noise (522e, i, j, k) a factor is a player miscommunication (522h).

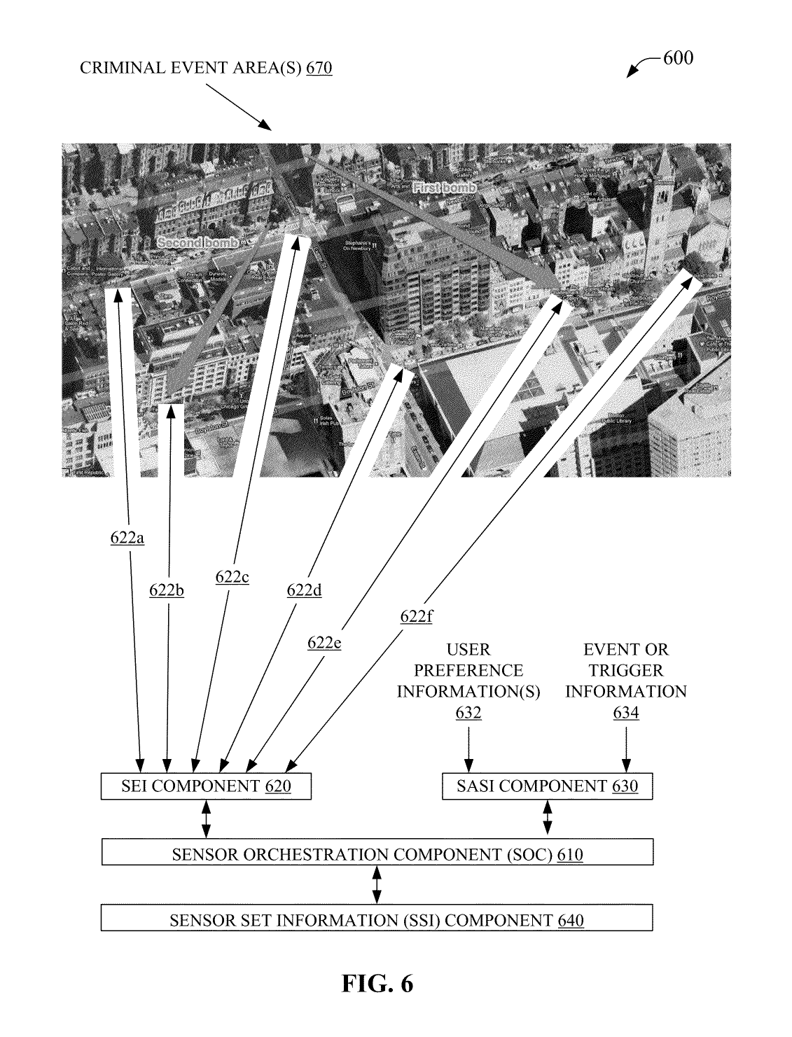

FIG. 6 illustrates example system 600 that facilitates sensor orchestration in a generally unconstrained environment in accordance with aspects of the subject disclosure. System 600 can include a generally unconstrained environment such as criminal event area 670. A generally unconstrained environment implies that some sensors of the environment are typically unconstrained and, as such, can move in or out of an area of interest. As an example, criminal event area 670 is generally unconstrained in that sensors on people or vehicles can easily move in or out of areas associated with the first or second bomb. System 600 can include sensor orchestration component (SOC) 610. SOC 610 can facilitate sensor orchestration for an unconstrained environment, such as criminal event area 670, based on information pertaining to available sensors and a criterion related to sensor selection of activation. As such, SOC 610 can receive sensor information via environment information (SEI) component 620. Sensor information can comprise information about a sensor related to criminal event area 670. In an aspect, SEI component 620 can enable access to sensor information that can comprise, for example, a list of available sensors related to criminal event area 670, identification information for a sensor related to criminal event area 670, feature information for a sensor related to criminal event area 670, measurement information from a sensor related to criminal event area 670, etc. It will be noted that nearly any information pertaining to a sensor or operation of a sensor related to criminal event area 670 can be accessed via SEI component 620 and that all such information is considered within the scope of the instant disclosure. SEI component 620 can facilitate learning about what sensors are associated with criminal event area 670, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set. In certain embodiments, SEI component 620 can facilitate ranking of a plurality of sensors associated with criminal event area 670 based on one or more characteristics or features that can facilitate selection of particular sensors. An orchestrated sensor set can comprise none, some, or all sensors associated with criminal event area 670. Further, where there is a large plurality of sensors in an environment, it can be expected that the most appropriate sensors can be selected for inclusion in the orchestrated sensor set based on selection rules or algorithms applied by SOC 610.

SOC 610 can further receive selection criteria via sensor activation or selection information (SASI) component 630. SASI component 630 can be employed, in conjunction with SEI component 620, by SOC 610 to facilitate selecting a sensor associated with criminal event area 670 for inclusion in an orchestrated sensor set. In an embodiment, SASI component 630 can receive preference information, e.g., user preference information 632, related to sensor selection. In another embodiment, SASI component 630 can receive event or trigger information 634 that can aid in selection of an appropriate sensor from those associated with criminal event area 670.

SOC 610 can be coupled to sensor set information (SSI) component 640 that can facilitate access to information related to sensors comprising an orchestrated sensor set. SSI component 640, in certain embodiments, can also enable access to measurement information from sensors of an orchestrated sensor set. In further embodiments, SSI component 640 can facilitate access to sensor interaction information. In some embodiments, SSI component 640 can enable SOC 610 to interact with and/or adapt sensor features of a sensor of an orchestrated sensor set, e.g., via a VM, while also facilitating access to measurement data and sensor data from the sensor of the orchestrated sensor set. An orchestrated sensor set can reduce redundancy of sensors which can be associated with lower data transport burdens and/or costs, improved battery life, etc. Further, intelligent sensor selection and coordinated use of sensor resources from an environment can be associated with selection of the best sensor(s) for a task, collaborative use of sensors in an environment, improved resource optimization, adaptation of a sensor feature(s), etc.

In an embodiment, SOC 610 can coordinate sensor use for a plurality of sensors comprising an orchestrated sensor set. This coordination between disparate sensors of the orchestrated sensor set can comprise coordination between instances of VMs associated with the several sensors of the orchestrated sensor set. Wherein a VM can facilitate interaction with a sensor, such as via SSI component 640, coordination between VM instances can facilitate coordination between a plurality of sensors. As illustrated, multiple sensors associated with criminal event area 670 can communicate with SEI component 620. SEI component 620 can receive information related to sensors, such as, traffic camera sensor information 622a, seismic sensor information 622b, vehicular device sensor set information 622c, pedestrian device sensor set sensor information 622d, audio sensor information 622e, teller machine (ATM) image sensor information 622f, etc. The information feeds from these sensors can be selected for inclusion in an orchestrated sensor set. It will be noted that some sensors may not be made available to the general public and sensors included in a first orchestrated sensor sets do not preclude inclusion in another orchestrated sensor sets.

Criminal event area 670 can represent, for example, the 2013 Boston marathon bombings environment. A runner or observer of the marathon event can use SOC 610 to employ an orchestrated sensor set that can provide access to sensor data that the runner or observer might find interesting, e.g., seeing when runners pass the traffic camera at 622a, monitoring an audio feed from a pedestrian smartphone microphone at 622e, etc. Law enforcement, prior to the actual bombings, can similarly employ SOC 610 to monitor conditions in the areas along the marathon route in an effort to prevent or mitigate crimes. Importantly, given the huge number of sensors at the 2013 Boston marathon, sensor selection criteria provides an effective way to select sensors that are relevant, to add newly relevant sensor, e.g., those moving into the area, to remove irrelevant sensors, e.g., those moving out of the area, to remove redundant sensors from the set, etc. Further, upon the explosion of the first bomb (near 622f) the selection criteria can be altered, e.g., at 634, allowing for inclusion of more redundant sensors in the hopes that one of them may provide better sensor data than another. Moreover, where a suspect is noted, e.g., a man in a white baseball hat worn backwards, sensors can be adapted via their VM instances to orient so as to form a sensor net that can better enable tracking of the suspect across the sensors, for example, CCTV cameras, traffic cams, ATM cams, and police vehicle dash cams can be selected based on orientation providing some uniformity of coverage of the sidewalks, or can be adapted (directed) to point towards an area in need of coverage, thereby allowing police to better track a suspect as they pass from one sensor area into an adjacent sensor area. In an aspect, the sensor data available through the devices of the public attending the event could also be polled to allow a centralized data feed for advance analysis techniques, such as those employed by the FBI, etc. Public devices could also be excluded, for example, based on location, orientation, status, available bandwidth, etc.

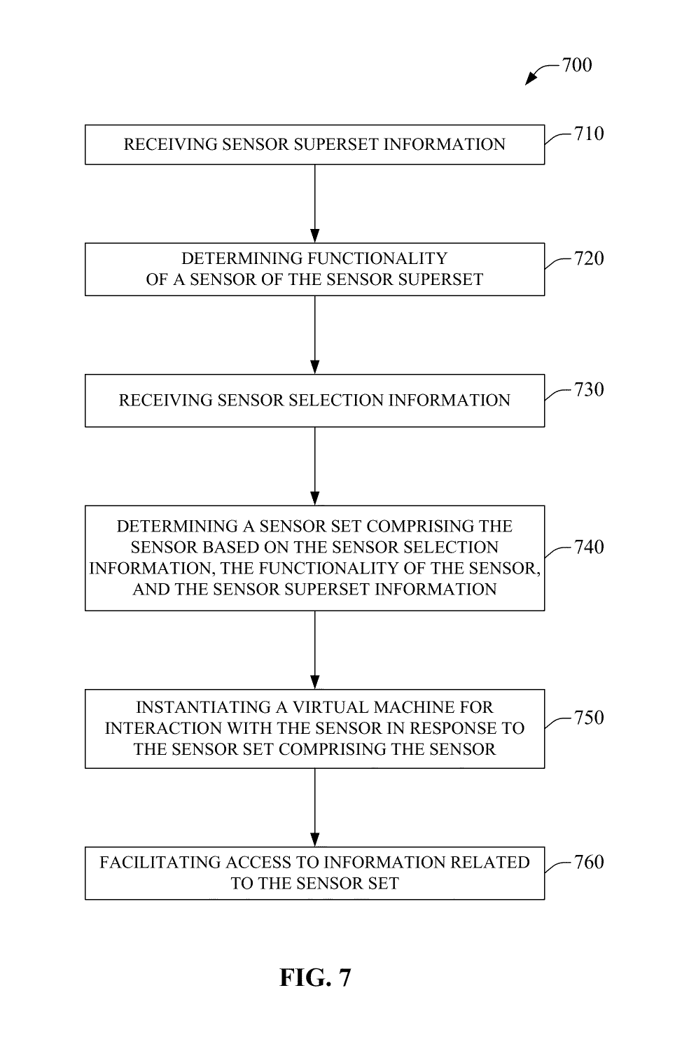

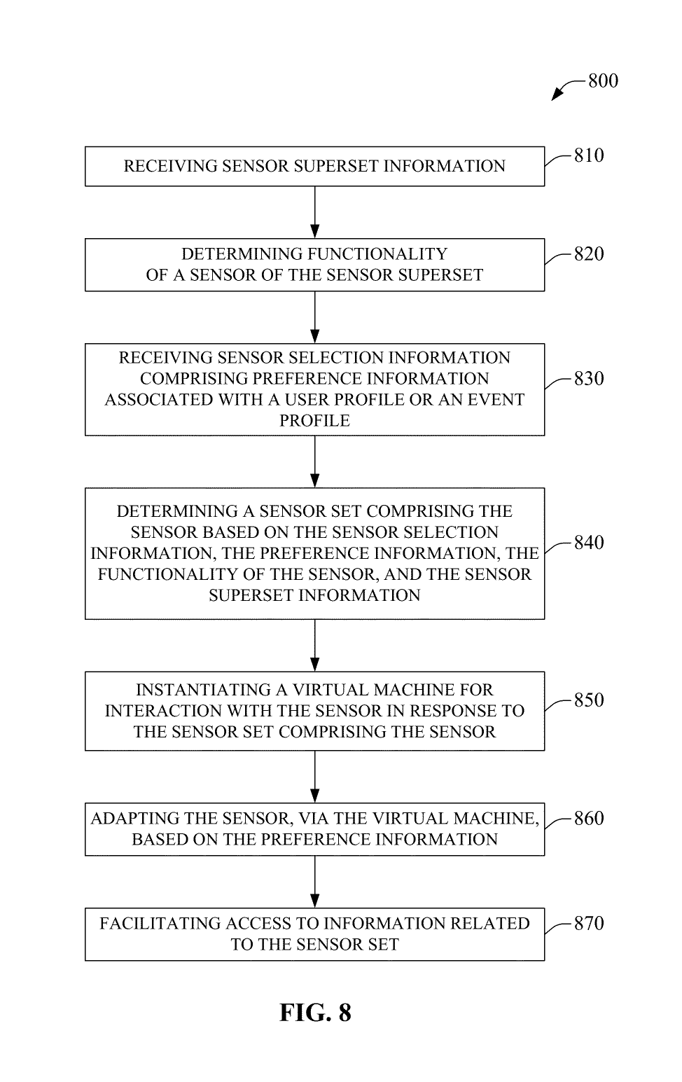

In view of the example system(s) described above, example method(s) that can be implemented in accordance with the disclosed subject matter can be better appreciated with reference to flowcharts in FIG. 7-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 7 illustrates a method 700 that facilitates sensor orchestration in accordance with aspects of the subject disclosure. At 710, method 700 can include receiving sensor superset information. Sensor super set information can be related to sensors deployed in an environment, at least some of which are available for inclusion in an orchestrated sensor set. In an embodiment, sensor superset information can comprise a list of available sensors for an environment, identification information for a sensor in the environment, feature information for a sensor in the environment, measurement information from a sensor in the environment, etc. It will be noted that nearly any information pertaining to a sensor or operation of a sensor in an environment can be included in sensor superset information and that all such information is considered within the scope of the instant disclosure. Sensor superset information can facilitate learning about what sensors are in an environment, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set. In certain embodiments, sensor superset information can facilitate ranking of a plurality of sensors from an environment in view of one or more characteristics or features of the particular sensors. In environments with pluralities of available sensors, this aspect can allow selection of none, some, or all sensors of the environment for inclusion in the orchestrated sensor set. Further, where there is a large plurality of sensors in an environment, it can be expected that the most appropriate sensors can be selected for inclusion in the orchestrated sensor set based on selection rules or algorithms applied to the sensor superset information received at 710.

At 720, a functionality of a sensor of the superset from 710 can be determined. Sensor functionality can be determined directly where the sensor reports the functionality as a part of the information received at 710. Further, where functionality is not directly reported, functionality can be determined either by a query of the sensor, by query of another source based on a sensor unique identifier included in the information at 710 or a query of the sensor, by query of another source based on a sensor type or model included in the information at 710 or a query of the sensor, etc.

At 730, sensor selection information can be received. Sensor selections information can be the same as, or similar to SASI as disclosed hereinabove. In an embodiment, sensor selection information can comprise a preference, e.g., a user preference, related to sensor selection. As an example, a preference can indicate that sensor selection should prefer newer sensors to older sensors, static sensor over mobile sensors, etc. In another embodiment, sensor selection information can comprise event or trigger information that can aid in selection of an appropriate sensor from an environment. As an example, event information can indicate a type of sensor to be selected, desired triggering speed, location, probability of continued relevance as a function of time, etc. At 740, method 700 can comprise, determining a sensor set, e.g., an orchestrated sensor set, comprising the sensor based on the sensor selection information, the functionality of the sensor, and the sensor superset information.

At 750, a virtual machine can be instantiated to interact with a sensor in response to a sensor set comprising the sensor. In an embodiment, an orchestrated sensor set can comprise a plurality of coordinated sensors. This coordination between disparate sensors of the orchestrated sensor set can be based on coordination between instances of VMs associated with the several sensors of the orchestrated sensor set. Wherein a VM can facilitate interaction with a sensor, coordination between VM instances can facilitate coordination between a plurality of sensors.

At 760, method 700 can comprise, facilitating access to information related to the sensor set, e.g., the orchestrated sensor set. At this point, method 700 can end. The information related to the sensor set can comprise a list of sensors comprising the sensor set. In certain embodiments, the information can also comprise measurement information from sensors, sensor interaction information, e.g., communication protocols, control signaling, network credentials, etc., information about the sensors allowing other components to initiate contact with the sensors of the orchestrated sensor set, etc. In some embodiments, the information related to the sensor set can enable interaction with and/or adaption of sensor features, while also facilitating access to measurement data from the sensor. Large numbers of sensors can be deployed in an environment and by allowing inclusion of a sensor in an orchestrated sensor set redundancy of sensors can be reduced, which can be associated with lower data transport burdens and/or costs, improved battery life, etc. Further, intelligent selection and use of sensor resources from a superset of sensors for an environment can be associated with selection of the best sensor(s) for a task, collaborative use of sensors in an environment, improved resource optimization, adaptation of a sensor feature(s), etc.

FIG. 8 illustrates a method 800 that facilitates sensor orchestration comprising sensor adaptation via a virtual machine instance in accordance with aspects of the subject disclosure. At 810, method 800 can include receiving sensor superset information. In an embodiment, sensor superset information can comprise a list of available sensors in an environment, identification information for a sensor, feature information for a sensor, measurement information from a sensor, etc. It will be noted that nearly any information pertaining to a sensor or operation of a sensor in an environment can be included in sensor superset information and that all such information is considered within the scope of the instant disclosure. Sensor superset information can facilitate learning about what sensors are in an environment, what their capabilities are, how to interact with the sensor, the status or availability of the sensor to be included in an orchestrated sensor set, a sensor pedigree, sensor conditions, etc. This information can be employed to determine aspects of a sensor, or operation thereof, which can be employed in determining if the sensor is to be included in an orchestrated sensor set. In certain embodiments, sensor superset information can facilitate ranking of a plurality of sensors from an environment in view of one or more characteristics or features of the particular sensors. In environments with pluralities of available sensors, this aspect can allow selection of none, some, or all sensors of the environment for inclusion in the orchestrated sensor set. Further, where there is a large plurality of sensors in an environment, it can be expected that the most appropriate sensors can be selected for inclusion in the orchestrated sensor set based on selection rules or algorithms applied to the sensor superset information received at 810.

At 820, a functionality of a sensor of the superset from 810 can be determined. Sensor functionality can be determined directly where the sensor reports the functionality as a part of the information received at 810. Further, where functionality is not directly reported, functionality can be determined either by a query of the sensor, by query of another source based on a sensor unique identifier included in the information at 810 or a query of the sensor, by query of another source based on a sensor type or model included in the information at 810 or a query of the sensor, etc.

At 830, sensor selection information can be received. Sensor selections information can be the same as, or similar to SASI as disclosed hereinabove. In an embodiment, sensor selection information can comprise a preference, e.g., a user preference, an event profile, etc., related to sensor selection. In some embodiments, sensor selection information can comprise event or trigger information that can aid in selection of an appropriate sensor from an environment. As an example, event information can indicate a type of sensor to be selected, desired triggering speed, location, probability of continued relevance as a function of time, etc. At 840, method 800 can comprise, determining a sensor set, e.g., an orchestrated sensor set, comprising the sensor based on the sensor selection information, the preference information, the functionality of the sensor, and the sensor superset information.

At 850, a virtual machine can be instantiated to interact with a sensor in response to a sensor set comprising the sensor. In an embodiment, an orchestrated sensor set can comprise a plurality of coordinated sensors. This coordination between disparate sensors of the orchestrated sensor set can be based on coordination between instances of VMs associated with the several sensors of the orchestrated sensor set. Wherein a VM can facilitate interaction with a sensor, coordination between VM instances can facilitate coordination between a plurality of sensors.

At 860, method 800 can comprise, adapting the sensor based on the preference information. Adapting the sensor can be by interaction with the sensor through the VM of 850. VM instantiation can result in one or more instances of VMs running. These VMs can be employed to interact with the one or more sensors of the sensor set, e.g., the orchestrated sensor set. Further, tailored VMs can be run that enable access to specialized features of certain sensors and/or adaptation of sensor features. In an embodiment, the use of VM instances for interaction with sensors can enable rapid and dynamic interaction with a plurality of sensors of the sensor set by simply accessing a library of VMs and selecting an appropriate VM for an available sensor. Thus, changes in sensors comprising the sensor set can quickly be accommodated by adding or removing an instance of an appropriate VM.

At 870, facilitating access to information related to the sensor set, e.g., the orchestrated sensor set. At this point, method 800 can end. The information related to the sensor set can comprise a list of sensors comprising the sensor set. In certain embodiments, the information can also comprise measurement information from sensors, sensor interaction information, e.g., communication protocols, control signaling, network credentials, etc., information about the sensors allowing other components to initiate contact with the sensors of the orchestrated sensor set, etc. In some embodiments, the information related to the sensor set can enable interaction with and/or adaption of sensor features, while also facilitating access to measurement data from the sensor. In some embodiments, large numbers of sensors can be deployed in an environment and by allowing inclusion of a sensor in an orchestrated sensor set redundancy of sensors can be reduced, which can be associated with lower data transport burdens and/or costs, improved battery life, etc. Further, intelligent selection and use of sensor resources from a superset of sensors for an environment can be associated with selection of the best sensor(s) for a task, collaborative use of sensors in an environment, improved resource optimization, adaptation of a sensor feature(s), etc.

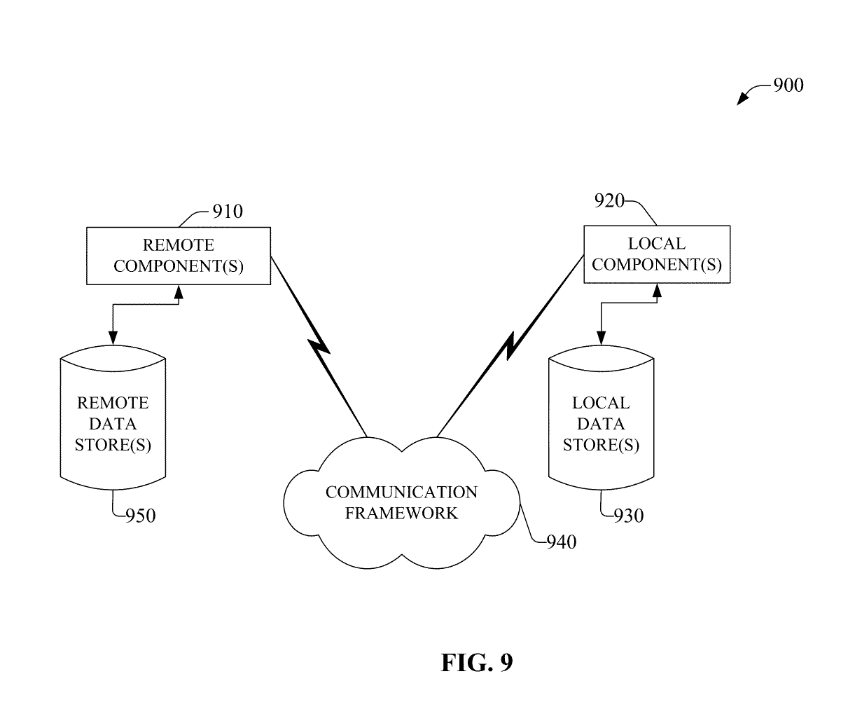

FIG. 9 is a schematic block diagram of a computing environment 900 with which the disclosed subject matter can interact. The system 900 includes one or more remote component(s) 910. The remote component(s) 910 can be hardware and/or software (e.g., threads, processes, computing devices). In some embodiments, remote component(s) 910 can include servers, personal servers, wireless telecommunication network devices, etc. As an example, remote component(s) 910 can be a sensor device. As another example, remote component(s) 910 can be a server associated with lookup information for sensor types. As a further example, remote component(s) 910 can be a server associated with providing virtual machine modules to facilitate running an instance of a VM for a particular sensor or sensor type.

The system 900 also includes one or more local component(s) 920. The local component(s) 920 can be hardware and/or software (e.g., threads, processes, computing devices). In some embodiments, local component(s) 920 can include a mobile device comprising SOC 110-610, etc. As an example, local component(s) 920 can be a smartphone configured to interact with an orchestrated sensor set and comprising a sensor orchestration component, e.g., SOC 110-610.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. As an example, information related to sensors of an environment, sensor measurements, sensor adaptation/control via a VM, etc., can be communicated over a packet-switched or circuit-switched channels between remote component 910, and a mobile device, e.g., a local component 920, via an air interface, such as on a packet-switched or circuit-switched downlink channel. The system 900 includes a communication framework 940 that can be employed to facilitate communications between the remote component(s) 910 and the local component(s) 920, and can include an air interface, e.g., Uu interface of a UMTS network. Remote component(s) 910 can be operably connected to one or more remote data store(s) 950, such as an available VM instance store, sensor information store, sensor data buffer, etc., that can be employed to store information on the remote component(s) 910 side of communication framework 940. Similarly, local component(s) 920 can be operably connected to one or more local data store(s) 930, that can be employed to store information, such as received sensor data, received sensor measurement information, employed VM instances, etc., on the local component(s) 920 side of communication framework 940.

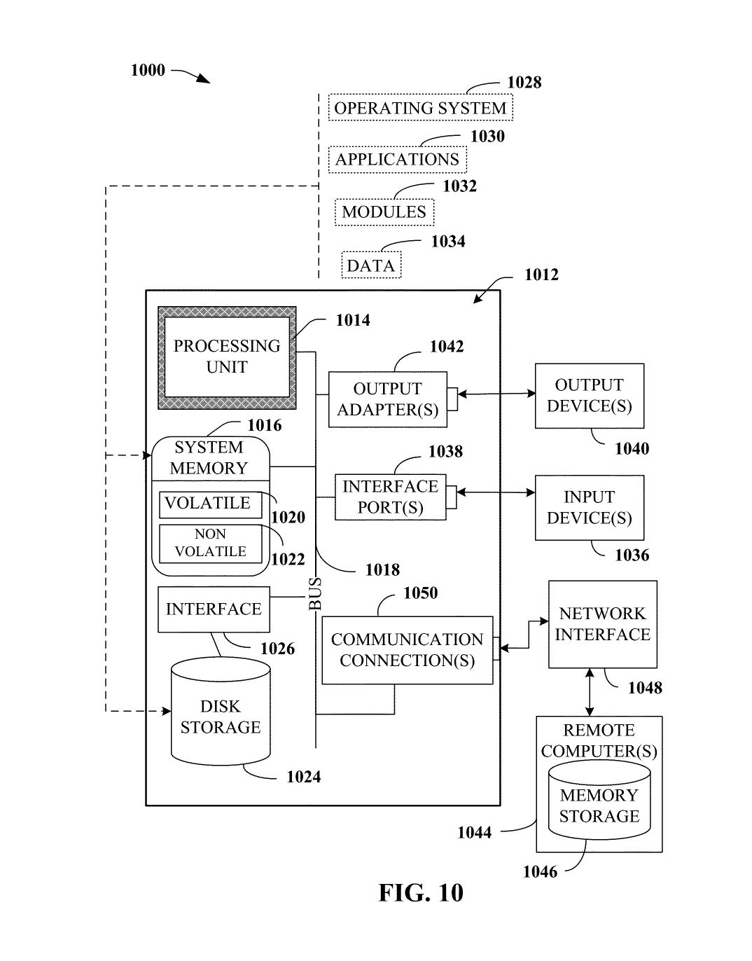

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, including single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of SOC 110-610, sensor(s) 322, etc., or employing method 700 or 800, etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can include volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can include read only memory, programmable read only memory, electrically programmable read only memory, electrically erasable read only memory, or flash memory. Volatile memory 1020 includes read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, Synchlink dynamic read only memory, Rambus direct read only memory, direct Rambus dynamic read only memory, and Rambus dynamic read only memory.

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, a user interface can allow entry of user preference information 232, 432-632, etc., and can be embodied in a touch sensitive display panel, a mouse input GUI, a command line controlled interface, etc., allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044. As an example, vehicle subsystems, such as headlights, brake lights, stereos, vehicle information sharing device, etc., can include an output adapter 1042 to enable use in accordance with the presently disclosed subject matter.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies include fiber distributed data interface, copper distributed data interface, Ethernet, Token Ring and the like. Wide area network technologies include, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and digital subscriber line modems, integrated services digital network adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include broadcast technologies (e.g., sub-Hertz, extremely low frequency, very low frequency, low frequency, medium frequency, high frequency, very high frequency, ultra-high frequency, super-high frequency, terahertz broadcasts, etc.); Ethernet; X.25; powerline-type networking, e.g., Powerline audio video Ethernet, etc; femto-cell technology; Wi-Fi; worldwide interoperability for microwave access; enhanced general packet radio service; third generation partnership project, long term evolution; third generation partnership project universal mobile telecommunications system; third generation partnership project 2, ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system comprising:
a processor; and
a memory that stores executable instructions that, when executed by the processor, facilitate performance of operations, comprising:
receiving sensor information about a sensor device;
determining a set of sensor devices comprising the sensor device;
instantiating a virtual machine to interact with the sensor device of the set of sensor devices;
facilitating adapting a sensor function of the sensor device via the virtual machine; and
facilitating access to event information related to an event, wherein a portion of the event information is captured by the sensor device.

2. The system of claim 1, wherein the determining the set of sensor devices comprises selecting the sensor device, based on the sensor information, to facilitate a reduction of redundant event information captured by the set of sensor devices.

3. The system of claim 1, wherein the determining the set of sensor devices comprises selecting the sensor device, based on the sensor information, to facilitate an increase in non-redundant event information captured by the set of the sensor devices.

4. The system of claim 1, wherein the sensor device is a first sensor device, the virtual machine is a first virtual machine, the portion of the event information is a first portion, and the operations further comprise:
instantiating a second virtual machine to interact with a second sensor device of the set of sensor devices;
facilitating adapting a second sensor function of the second sensor device via the second virtual machine; and
facilitating access to the event information, wherein a second portion of the event information is captured by the second sensor device.

5. The system of claim 4, wherein the determining the set of sensor devices, comprising the first sensor device and the second sensor device, comprises determining that the event information comprises less redundant event information than other event information captured by another set of sensor devices comprising the first sensor device and a third sensor device.

6. The system of claim 1, wherein the facilitating the adapting of the sensor function comprises:
designating an adapted sensing region that is an adaptation of a sensing region associated with the sensor device, and
capturing the event information from the adapted sensing region.

7. The system of claim 1, wherein the determining the set of sensor devices is in response to a parameter value associated with the event being determined to satisfy a threshold value rule related to a threshold value.

8. The system of claim 1, wherein the set of sensor devices is a first set of sensor devices, and the operations further comprise:
determining a second set of sensor devices comprising the sensor device and that is different than the first set of sensor devices.

9. The system of claim 1, further comprising:
a mobile device comprising the memory and the processor.

10. A method, comprising:
receiving, by a system comprising a processor, sensor information about a sensor device deployed in an environment;
receiving, by the system, event information associated with an event, wherein the event information facilitates determining a set of sensor devices comprising the sensor device germane to measuring a defined phenomenon related to the event;
determining, by the system, the set of sensor devices based on the sensor information and the event information, wherein the set of sensor devices facilitates measuring the defined phenomenon related to the event;
adapting, by the system, a sensor function of the sensor device via an instance of a virtual machine; and
facilitating, by the system, access to measurement information related to the measuring of the defined phenomenon.

11. The method of claim 10, wherein the determining the set of sensor devices reduces redundancy in the measuring of the defined phenomenon related to the event.

12. The method of claim 10, wherein the determining the set of sensor devices increases non-redundant information in the measuring of the defined phenomenon related to the event.

13. The method of claim 10, wherein the determining the set of sensor devices is in response to a parameter value associated with the event being determined to satisfy a rule related to a threshold value.

14. The method of claim 10, further comprising adapting, by the system, another sensor function of another sensor device of the set of sensor devices via another instance of another virtual machine.

15. The method of claim 10, wherein the determining the set of sensor devices is based on determining, by the system, a rank order for sensor devices deployed in the environment, and including sensor devices in the set of sensor devices according to the rank order.

16. The method of claim 10, wherein the determining the set of sensor devices comprising the sensor device does not preclude determining, by the system, a different set of sensor devices comprising the sensor device.

17. A computer readable storage device comprising executable instructions that, in response to execution, cause a system comprising a processor to perform operations, comprising:
receiving sensor information about a sensor device;
determining a set of sensor devices comprising the sensor device, the set of sensor devices to be employed in capturing event information related to an event;
instantiating a virtual machine to interact with the sensor device of the set of sensor devices;
initiating adaptation of a sensor function of the sensor device via the virtual machine; and
facilitating access to a set of the event information captured by the sensor device.

18. The computer readable storage device of claim 17, wherein the determining the set of sensor devices comprises selecting the sensor device, based on the sensor information, resulting in a reduction in redundant event information captured by other sensor devices of the set of sensor devices.

19. The computer readable storage device of claim 17, wherein the determining the set of sensor devices comprises selecting the sensor device, based on the sensor information, resulting in an increase in non-redundant event information captured by other sensor devices of the set of sensor devices.

20. The computer readable storage device of claim 17, wherein the sensor device, of the determining a set of sensor devices comprising the sensor device, is a sensor device comprised in another set of sensor devices.
